(19) United States
(12) Patent Application Publication
(10) Pub. No.: US 2005/0045428 A1
(43) Pub. Date: Mar. 3, 2005

(54) Elevator with a scissor lift assembly and a central drive mechanism

(76) Inventors: Jean-Marie Rennetaud, Fox River Valley Gardens, IL (US); Tian Zhou, Reussbuhl (CH)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/914,441

(22) Filed: Aug. 9, 2004

(30) Foreign Application Priority Data
Sep. 2, 2003 (EP) 03405631.7

(51) Int. Cl. B66B 9/02

(52) U.S. Cl. 187/269; 187/211

(57) ABSTRACT

An elevator installation has a scissor assembly for lifting an elevator car, the assembly being supported on the ground underneath the elevator car. The scissor assembly includes two scissor columns vertically arranged, with each column having at least one pair of arms which are pivotally movable relative to one another. The scissor columns are mechanically coupled by at least one cross element and a drive mechanism mechanically interacts with both scissor columns for applying a force in the vertical direction for unfolding the scissor assembly.

### BACKGROUND OF THE INVENTION

The present invention generally relates to elevators and, more particularly, is concerned with elevators with a scissor lift mechanism.

In various work platform lift machines, such as scissors lifts, elevated platforms, cranes, etc., hydraulic cylinders are used to provide the necessary lifting forces. The hydraulic cylinders are typically part of a hydraulic actuation system for operating the lift mechanism to raise and lower the work platform. The scissors lift mechanism includes a plurality of pairs of arms pivotally interconnected in a scissor-like fashion so as to raise and lower as the arms pivot between generally vertical unstacked and horizontal stacked orientations relative to one another. The hydraulic actuation system generally employs an even number of hydraulic cylinders for causing pivoting of the pairs of arms to expand the lift mechanism. Typically, the hydraulic cylinders are interconnected between an adjacent set of the arms.

An example of a lift machine with two symmetrically arranged hydraulic actuation systems is described in the U.S. Pat. No. 5,375,681, which belongs to the same family as the German patent application DE 42 25 871-A1. Each of the two hydraulic actuation systems provides for the up and down movement of one of two scissor columns, which together carry a car. Two vertical guiding means are provided which are symmetrically arranged with respect to the scissor columns of the lift machine. The guiding means are rather complicated and the actuation of the two hydraulic actuation systems has to be synchronized.

The German patent applications DE 42 34 490-A1 and DE 43 13 068-A1 disclose various lift machines with an even number of synchronized hydraulic actuation systems. There are two vertical scissor columns, each of which is lifted by a corresponding one of said hydraulic actuation systems. The lowermost ends of the arms of the scissors are guided above ground (cf. FIGS. 3 and 4 of DE 42 34 490-A, for instance) to ensure that they are not lifted if upwards oriented forces are applied to the scissor columns.

The use of hydraulic actuation systems and positioning of the hydraulic cylinders in lift machines have several disadvantages. One major disadvantage is that hydraulic actuation systems tend to leak hydraulic fluid which is a substance toxic to the environment and therefore requires a considerable amount of care and attention and must be contained and disposed of properly. Another significant disadvantage of hydraulic actuation systems is that they are not very efficient, typically operating at levels up to approximately fifty percent efficiency. Thus, lift machines that are hydraulically powered not only invite high maintenance and/or repair costs, but also tend to consume quite some power.

Yet another important disadvantage is that using hydraulic cylinders within the scissors arm stack to raise the lift mechanism not only causes machine instability due to high centers of gravity, but also such hydraulic cylinders tend to be squishy and jerky in operation and thus hydraulic actuation systems lack smooth and precise control of the movement of the lift mechanism to raise and lower the working platform. The design rules of work platforms with scissor assembly cannot be easily applied to elevators for carrying passengers, since an elevator for passengers usually has to move faster and smoother and has to reach the respective landing levels more precisely. Furthermore, the comfort is an issue.

It is yet another disadvantage that in many scissor systems two scissor columns are used in parallel and concurrently in order to provide the required stability. In such scissor systems, typically two hydraulic cylinders are employed which have to be synchronized in order to provide for a concurrent movement of the two scissor assemblies, as mentioned in connection with the above patents and patent applications.

There are scissor lift mechanisms, such as scissor jacks for lifting vehicles, that are manually actuated. An example of a scissor jack with a double-lead ACME threaded screw shaft is disclosed in the U.S. Pat. No. 6,527,251, for example. The ACME mechanism provides for a self-locking function.

Some scissor lift mechanisms comprise an electro-mechanical screw drive instead of hydraulic cylinders. An example of a work platform with a scissor lift mechanism and telescopable electro-mechanical screw drive is disclosed in the U.S. Pat. No. 6,044,927. The screw drive comprises a non-threaded extension tube in a telescopable support relationship with a threaded ballscrew shaft. The screw drive extends between two pivotally movable arms of the scissor assembly. The ballscrew shaft undergoes a pivotal movement, which is a disadvantage of this mechanism.

Another scissor lift mechanism comprising an electromechanical screw drive is disclosed in the U.S. Pat. No. 4,451,945. This patent concerns a medical couch with a central electromechanical screw drive. The screw drive is pivotally connected to a lower frame and performs a tilting movement as the couch is lifted or lowered. That is, the drive pivots about a horizontal axis. The connection between the drive and the lower frame, as well as the coupling of a nut moving up and down as the shaft rotates, are mechanically complicated. In one of the embodiments disclosed in this patent, the nut is a ball nut.

A further scissor lift mechanism comprising an electromechanical screw drive is disclosed in the U.S. Patent application with publication number US 2002/0029930-A1. Disclosed is a lift mechanism with drive having a horizontally arranged ballscrew shaft. A rotation of this shaft moves one end of a lower arm of a scissor assembly in a horizontal direction. This horizontal movement causes the scissor assembly to fold or unfold. Since the ballscrew shaft is horizontally arranged, the drive must provide high force levels in order to unfold the scissor lift mechanism in the vertical direction, in particular on the condition that the scissor lift mechanism is almost unfolded (i.e. if a load carried by the lift mechanism is held on a height which is close to the lowest possible level). This is disadvantageous.

All these mechanisms and systems have certain disadvantages, as briefly addressed. In particular the actuation is still an issue that provides further room for improvements and new concepts.

Consequently, a need exists for a different approach to actuation of the scissors lift mechanism of such lift machines which will overcome the above-mentioned disadvantages without introducing other disadvantages in their place.

### SUMMARY OF THE INVENTION

The present invention concerns a scissor lift elevator assembly having the following advantages:
Stability is provided due to the fact that two scissor columns which are connected by cross elements are used in parallel.
Predefined landing levels can be precisely and reproducibly reached due to the fact that a precise drive (e.g., a screw drive) is employed that allows a very precise translational movement. This is an important issue since the scissor assembly “amplifies” small movements at the lower end into larger movements at the upper end. This amplification is particularly significant, if each scissor column comprises a plurality of pairs of arms, said pairs of arms being pivotably coupled to each other. In other words, the lift stroke of the highest pair of arms of the scissor assembly obtains a many times longer stroke relative to the very short stroke of the drive.
It improves control over and stability of the elevator.
The movements are very smooth.
No synchronization is needed as in conventional scissor elevators using two drives.
Disturbing vibrations are avoided when moving the elevator car up or down.
Due to the fact that the drive mechanism is arranged such that the entire force applied by the drive mechanism on the scissor columns always points upwards, that is even if the scissor assembly is in a completely retracted (folded) state, most of the force is used to lift a cross element and to unfold the scissors. As a consequence, the drive can be smaller (that is a drive of smaller power rating can be employed) compared to conventional solutions, or the drive can lift larger loads.
The power consumption is reduced, which is an important issue when employing a scissor elevator in a private home or in a building where only fuses of limited capacity or single phase (e.g., 220V) power supply are available.
It requires less maintenance than conventional systems.
Due to the central introduction of the driving force into the scissor assembly, the stress on the arms of the scissor assemblies is reduced which provides for significant performance and maintenance advantages.
It operates with a higher efficiency than systems with hydraulic actuation.
In particular when a screw drive is employed, the whole system is more rigid compared to hydraulic systems that have a tendency to yield down or bounce.
The elevator can be pre-fabricated and thus installed more easily on site. This helps to drastically reduce the overall costs of the elevator.
The lifting device of the present invention requires only small space for installment.
The lifting device of the present invention is “self-holding”, which means that a structure to hold or guide the elevator (such as guide rails as used for guiding an elevator car of a conventional elevator or ropes or flat ropes for holding an elevator car of a conventional elevator) is not necessary and the elevator of the invention can therefore be applied also in wooden buildings or even free-standing.
The on-site installment is less complicated and less time consuming. No mechanical experts are needed for the installment anymore.

The above advantages do not necessarily apply to all the different embodiments, since the embodiments are implementations of the invention with a focus on optimizing particular aspects. At the same time, however, other aspects might be less perfect.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1A is a schematic perspective representation of a first embodiment of an elevator according to the present invention;

FIG. 1B is an enlarged view of the first elevator shown in FIG. 1;

FIG. 2 is a schematic perspective representation of the lower part of a second embodiment of an elevator according to the present invention; and

FIG. 3 is an enlarged view of a lower part of a third embodiment of an elevator according to the present invention.

### DESCRIPTION OF THE PREFERRED EMBODIMENT

In the following description, like reference characters designate like or corresponding parts throughout the several views of the drawings. Also in the following escription, it is to be understood that such terms as “horizontal”, “vertical”, “left”, “right”, “upwards”, “downwards”, and the like are words of convenience and are not to be onstrued as limiting terms.

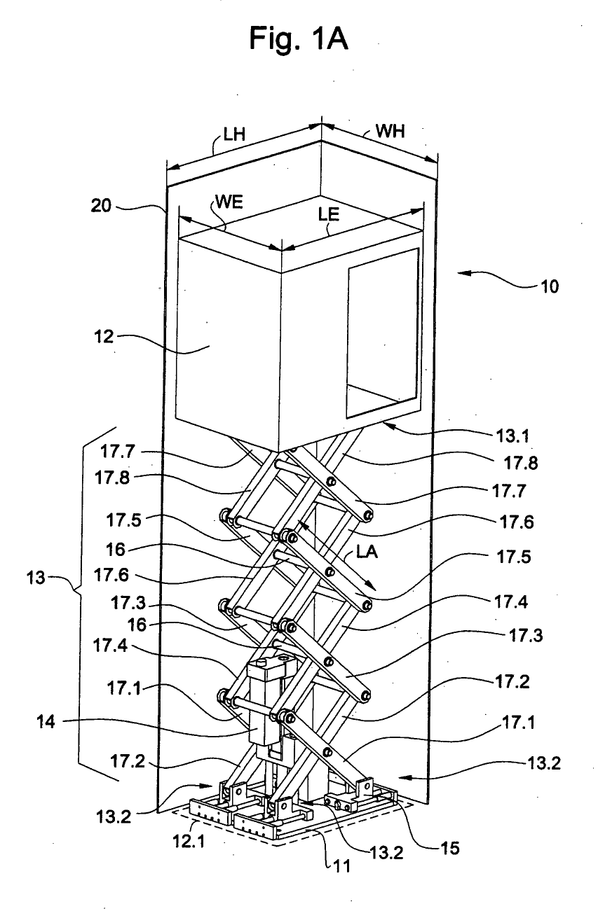

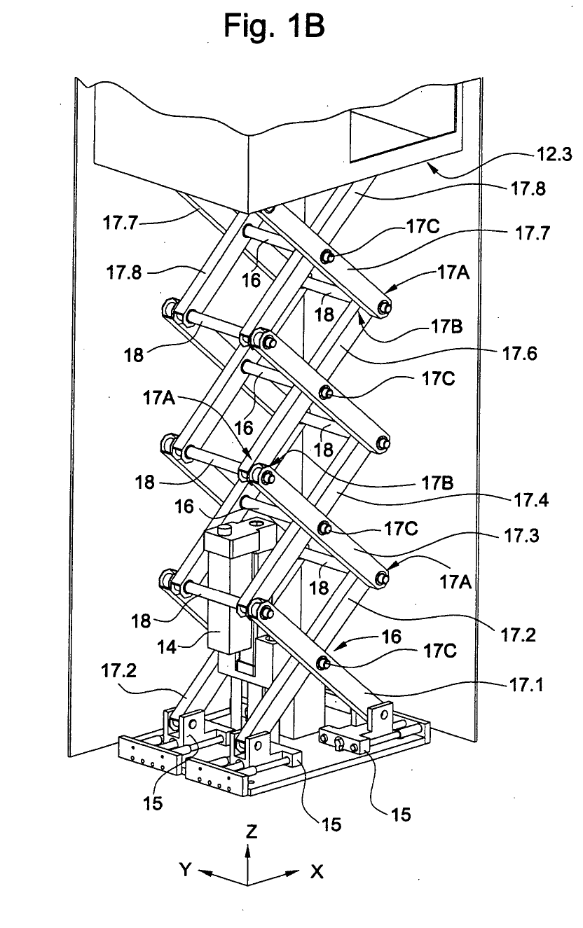

Referring to the drawings and particularly to FIGS. 1A to 3, there are illustrated various scissors-type elevators of the present invention.

In FIGS. 1A and 1B, a first embodiment of an elevator 10 is shown. The elevator 10 basically comprises an optional mounting platform 11, an elevator car 12, a scissor assembly 13, and an electromechanical drive 14. The elevator car 12 is disposed above the mounting platform 11. The scissor assembly 13 extends vertically between the mounting platform 11 and elevator car 12 and has four upper ends 13.1 (not visible in FIG. 1) pivotally mounting the elevator car 12 and four lower ends 13.2 horizontally mounted and guided by guiding means 15 on the mounting platform 11. The scissor assembly 13 comprises two scissor columns, which preferably are substantially identical to ensure symmetry of the overall system. The two scissor columns are situated parallel to each other on either side of the elevator car 12 and are connected by at least one horizontal cross element 16. A rod or tube may serve as cross element 16, for example. Each scissor arrangement comprises a plurality of portions in the form of pairs of arms 17.1 and 17.2, 17.3 and 17.4, 17.5 and 17.6, and 17.7 and 17.8 being pivotally interconnected in a scissors-like fashion and movable relative to one another between expanded and retracted conditions so as to move the elevator car 12 between raised and lowered positions relative to the mounting platform 11.

Each pair of arms of the scissor assembly 13 comprises two longitudinal arms 17.x wherein “x” represents consecutive odd and even integers. The lower most pair of arms comprises the two arms 17.1, 17.2, for example. The arms 17.x may have a solid or hollow tubular construction and they may have a substantially rectangular, circular, triangular or oval cross-section. Though the arms 17.x may have any other suitable configuration. A length LA of each arm 17.x is smaller than a respective length (side-to-side distance) LE of the elevator car 12 if the scissor assembly 13 is to stay within a projection 12.1 of the elevator car 12. In this case, a length (side-to-side) LH and a width (front-to-back) WH of an optional hoistway 20 is only slightly larger than the length LE and a width (front-to-back) WE of the elevator car 12. It is, however, also possible to employ arms 17.x having a length LA that is greater than the length LE of the elevator car 12.

Each arm, e.g. the arm 17.3, has a pair of opposite ends 17A, 17B, as illustrated in FIG. 1B, and is disposed in substantially parallel relation to the other respective arm 17.4 of the pair. The scissor assembly 13 also includes a plurality of intersection points 17C and the cross elements 16 horizontally extending between and pivotally connected respectively with corresponding ones of the arms 17.x at the intersection points 17C. The arm 17.3 is at its respective end 17B pivotally connected to the end 17A of the next arm 17.6, and so forth. Furthermore, there are optional cross elements 18 horizontally extending and pivotally connected respectively between corresponding ones of the arms 17.x of the two parallel scissor columns. The cross elements 18 may be connected to the arms 17.x at or close to the respective ends 17A, 17B.

The elevator car 12 is of any suitable type such as the one shown in FIG. 1A and FIG. 1B. An underside 12.3 of the elevator car 12 is mounted to the uppermost pairs of arms 17.7, 17.8 in a fashion that may be substantially similar to the mounting of the lowermost pairs of arms 17.1, 17.2 to the guiding means 15. The mounting is done in a way that the respective uppermost pairs of arms 17.7, 17.8 and lowermost pairs of arms 17.1, 17.2 can move in a horizontal direction “X” relative to the elevator car 12 and the mounting platform 11 so as to allow for the expansion and retraction of the scissor assembly 13.

The drive 14 is connected to the lowest cross element 16, which connects the lowest pairs of arms 17.1 and 17.2 of the scissor columns. The drive 14 is arranged such that, by activating the drive 14, a force acting on said cross element 16 in the vertical direction can be applied. Thus, the drive 14 is adapted to mechanically interact with both scissor columns for applying a force in the vertical direction for moving said cross-element 16 up or down and, thus, for folding and/or unfolding the scissor assembly 13.

Preferably, the electromechanical drive 14 is connected with a middle section of said cross element 16. This is advantageous in view of the mechanical stability of the elevator 10 since the force generated by the drive 14 acts symmetrically on the scissor assembly 13 in the same direction in which the elevator car 12 is moved.

The electromechanical drive 14 may be replaced by any drive providing an equivalent function.

Due to the fact that a scissor assembly 13 is employed, a small upwards movement of the lower most arms 17.1, 17.2 caused by the drive 14 is translated into a larger movement of the elevator car 12. The maximum movement of the drive 14 corresponds to the maximum expansion of the overall scissor assembly 13.

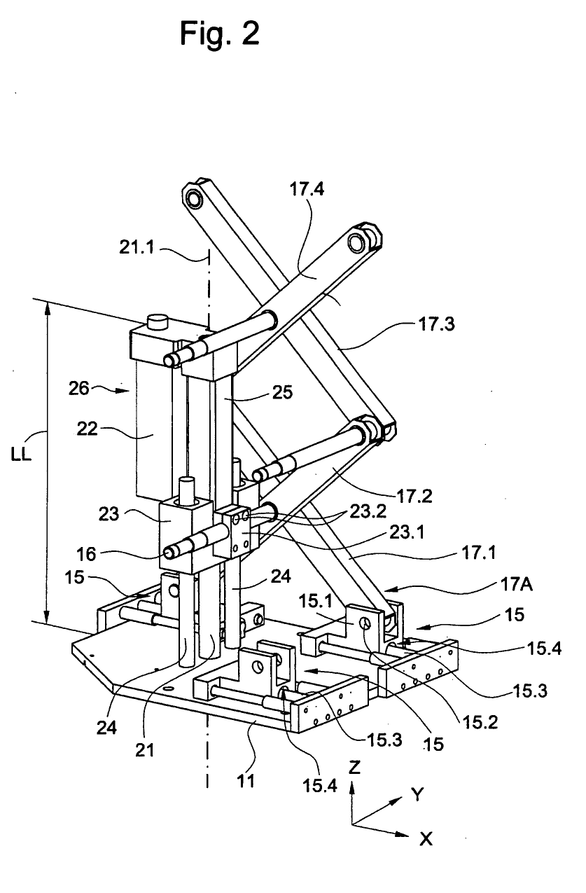

According to another preferred embodiment of the present invention, an electro-mechanical screw drive 26 is employed, as depicted in FIG. 2. The embodiment of FIG. 2 corresponds to the embodiment of FIG. 1A and FIG. 1B except the particulars of the arrangement of the screw drive 26 (as compared with the drive 14 of FIGS. 1A and 1B). The screw drive 26 comprises a hollow shaft 21, an electric motor 22, an externally threaded screw, an internally threaded nut and a housing 25, which covers one end of the shaft 21, the screw and the nut. The screw and the nut are not visible in FIG. 2.

There are two basic designs of the screw drive 26, both of which can be used in connection with the present invention. Basically, the corresponding threads of the screw and the nut are engaged in such a way that, by rotating the nut with respect to the longitudinal axis of the screw or by rotating the screw around its longitudinal axis with respect to the nut, a linear motion of the screw with respect to the nut can be induced. The screw is arranged such, that it projects in a hollow space of the shaft 21. In one design of the screw drive 26, the nut is fixed at the shaft 21 and the screw is rotatable by means of the electric motor 22. In the other design of the screw drive 26, the screw is fixed at the shaft 21 and the nut is rotatable by means of the electric motor 22. By activating the electric motor 22, the shaft 21 may be linearly moved with respect to the electric motor 22 and the housing 25 in a longitudinal direction 21.1 of the shaft 21 by means of the screw and the nut. By reversing the angular direction of the rotation of the nut with respect to the longitudinal direction of the screw, the direction of the movement of the shaft 21 with respect to the electric motor 22 may be reversed.

The electric motor 22 may be an A.C. or a D.C. motor.

In the embodiment in accordance with FIG. 2, one end of the shaft 21 is fixed with respect to the mounting platform 11. The electric motor 22 is connected to the housing 25. The electric motor 22 and the housing 25 are connected to a sliding element 23. This sliding element 23 is guided on two vertical non-threaded shafts 24. A clamping member 23.1 comprises a through hole for insertion of one of the cross elements 16 of the scissor assembly 13, for example. Screws 23.2 are provided that allow the clamping member 23.1 to be tightened after insertion of the cross element 16. The two non-threaded shafts 24 precisely guide the sliding element 23 as it moves up or down.

Preferably, the electric motor 22 is arranged adjacent to the shaft 21. The overall length of the drive 26 is thus mainly defined by a shaft length LL. If the motor 22 would be arranged above or below the shaft 21, the overall length would be larger. With the motor 22 arranged at the side of the shaft 21, elevators can be realized that require less space below the lowest landing level.

Thus, by activating the electric motor 22, a linear movement of the electric motor 22 and the sliding element 23 in the vertical direction with respect to the mounting platform 11 can be induced. This linear movement forces the scissor assembly 13 to unfold and the elevator car 12 to move upwards, or the other way around.

The drive 26, as illustrated in FIG. 2, serves three purposes:
(1) It is especially adapted to mechanically interact with the cross element 16 for applying a force to the cross element 16 to move the elevator car 12 upwards by unfolding the scissor assembly 13.
(2) The drive 26 provides for a vertical guidance of the two scissor columns by directly guiding the cross element 16. In particular, the drive 26 does not perform any tilting or pivoting movements with respect to the scissor assembly. The guiding in the vertical direction can be improved by any guide element such as the shaft 24 which stabilizes the linear motion of the drive 26 and, thus, the movement of the scissor assembly 13.
(3) The electromechanical drive 26 is connected with a middle section of said cross element 16. This is advantageous in view of the mechanical stability of the elevator 10 since the force generated by the drive 26 acts symmetrically on the scissor assembly with respect to the direction in which the scissor assembly may be folded or unfolded.

In an alternative approach, the way the drive 26 interacts with the scissor assembly 13 can be modified. The electric motor 22 could be fixed with respect to the mounting platform 11 and the shaft 21 could be arranged in such a way that it is linearly movable in the vertical direction with respect to the electric motor 22 and that is adapted to mechanically interact with both scissor columns for applying a force in the vertical direction for unfolding the scissor assembly. For example, the shaft 21 could be fixed at the cross element 16.

Some of the embodiments described and claimed are designed such that the downward movement of the elevator car 12 occurs without having to actively drive the shaft in a second direction. The weight of the elevator car 12 and the load on or in the car 12 contribute to a force pulling the entire arrangement downwards. If the entire arrangement is balanced appropriately, the downward force is introduced via the engagement of the corresponding threads of the nut and the screw. Depending on the actual design of the nut and the screw, the force may be sufficient to cause a movement of the shaft 21 in a second direction with respect to the electric motor 22. Due to this movement, the sliding element 23 moves downwards. The elevator car 12 and the whole scissor assembly 13 follows this down movement.

The upper end 13.1 of the scissor assembly 13 pivotally mounts the elevator car 12, as depicted in FIGS. 1A and 1B. The scissor assembly 13 extends vertically between the ground and the elevator car 12. As illustrated in FIG. 1B, the lowermost arms 17.1, 17.2 of the pairs of arms are pivotally and movably mounted on the ground or on the mounting platform 11 situated on the ground.

In FIG. 2, details of this mounting arrangement are shown. Each of the lower ends of the four arms 17.1, 17.2 is mounted and guided in the respective guiding means 15. The lower end 17A of the arm 17.1 is pivotally connected to a horizontal slide 15.1. The arm 17.1 may be connected to the horizontal slide 15.1 by means of a pin 15.2, or equivalent means such as an axle (not shown) or screw (not shown), for example. The guiding means 15, according to the present embodiment, comprise a central non-threaded shaft 15.3 which is arranged parallel to the ground or parallel to the mounting platform 11. The horizontal slide 15.1 comprises a through hole 15.4 and the shaft 15.3 extends through this hole 15.4. In the present embodiment, there are four guiding means 15 situated on the mounting platform 15. The horizontal slides 15.1 can move parallel to the X-axis along the shafts 15.3.

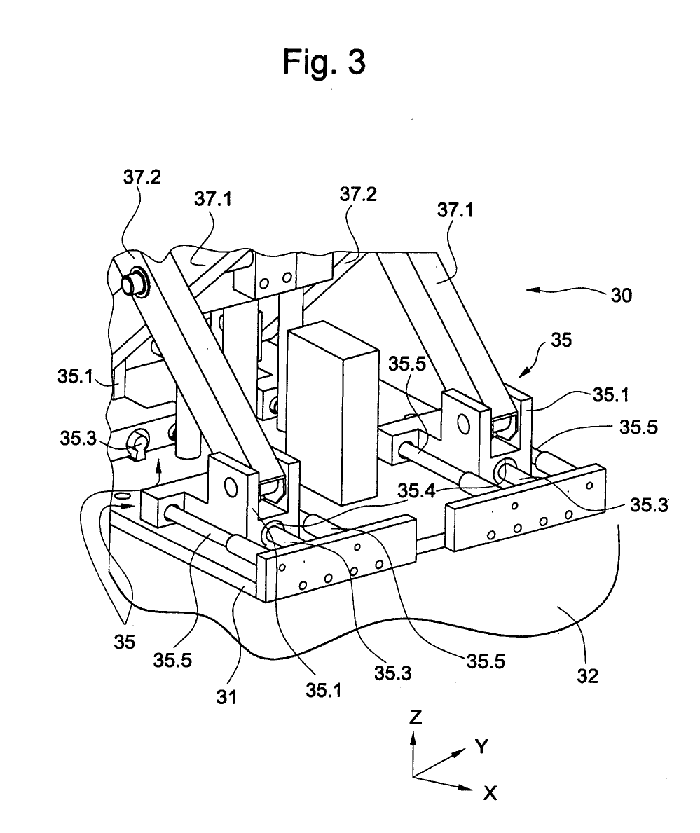

Another embodiment of an elevator scissor lift according to the present invention is illustrated in FIG. 3. FIG. 3 is an enlarged perspective view of just the lower portion of an elevator 30. The elevator 30 comprises a mounting platform 31 fixed on an essentially flat ground 32. There are again four guiding means 35 situated on the mounting platform 31, as in FIGS. 1A, 1B and 2. Each of the four guiding means 35 mounts and guides one of lower arms 37.1 and 37.2. A horizontal slide 35.1 of each guiding means 35 comprises a through hole 35.4 and a shaft 35.3 extending through the respective hole 35.4. The guiding means 35 further comprises a pair of cylindrical spring members 35.5. The spring members 35.5 might be horizontally guided. The spring members 35.5 bias the two horizontal slides 35.1 on the right hand side of the platform 31 to the left and the two horizontal slides 35.1 on the left hand side of the platform 31 to the right. The spring members 35.5 have to some extent the same function as a counterweight in a conventional elevator. For this reason, they are herein referred to as virtual counterweight.

In addition or alternatively, damping elements acting on the lower ends of the arms may be employed in an elevator or elevator assembly according to the present invention. For example, the enlarged portion of the spring member 35.5 can be a terminal buffer for damping a downward movement of the scissor assembly.

According to another embodiment, the electromechanical drive 26 is an ACME screw drive or a similar kind of screw drive with a high strength screw shaft and a nut made of bronze or a synthetic material. It is advantageous to use a high efficiency reinforced self-guided ACME nut. Well suited is a nut comprising a reinforced, lubricated resin material for higher strength, higher efficiency and greater thread accuracy. The ACME thread of the shaft mates with the ACME thread of the nut. It is an advantage of the “ACME embodiment” that the scissor assembly and the elevator car will not move downwards after the drive is switched off or after the drive failed. The friction between the special nut and the screw shaft is large enough to prevent the whole system from moving downwards. It is a further advantage of the ACME screw drive or a similar kind of screw drive that no separate brake(s) are required, since the movement of the nut with respect to the screw shaft is not reversible unless the motor drives the screw or the nut. Thus, the elevator cannot fall down, even in the absence of a safety gear or a safety brake. A load-holding brake is not required either for the same reason. It is a disadvantage, however, that the efficiency of a drive using an ACME screw may be somewhat reduced.

The embodiment with the ACME screw drive exhibits an operational advantage that derives from the physical characteristics which are unique to the ACME screw thread, namely the ability for the ACME screw to become self-locking when the elevator is subjected to loads. Where loading is above a given level, the frictional forces developed among the thread lands or roots of the threaded shaft and the nut become sufficiently large to prevent the vertically downward directed force from causing the screw shaft to unwind and prematurely allow the elevator to descend in an uncontrolled manner. It is required that a minimum load is exceeded before the ACME self-locking phenomenon takes effect.

In yet another embodiment, a ball screw drive with an externally threaded ballscrew shaft and an internally threaded nut, or a caged ball screw drive, or a planetary roller screw drive may be employed. These known kinds of screw drives are the equivalent of the drives 14 and 26 and are characterized by relatively low frictions which has the advantage that a smaller electrical drive can be employed for causing a movement of the elevator car. It is, however, a disadvantage, that a separate brake is required to stop the elevator car at a desired landing level and to control downwards oriented movements of the elevator car.

The mounting platform may be used to define the shape and size of the hoistway. As depicted in FIG. 3, the mounting platform 31 may comprise an edge, or the like, on which the vertical walls of the hoistway can be mounted. This makes the installment of the hoistway walls, which can be made from wood panels, easier.

The elevator car may comprise similar guiding means, with or without spring members, than the ones situated on the ground or mounting platform. The elevator car may be a platform with some kind of edge or balustrade, or it may be a cabin with or without sliding doors, for example.

In the FIGS. 1A, 1B, 2, and 3, elevators or elevator assemblies are shown that are mounted on a mounting platform. It is also possible to mount an elevator or elevator assembly, according to the present invention, right on the ground. In this case it is advantageous if the surface of the ground is essentially flat and if the ground is prepared (e.g., by using concrete) for being able to carry the respective loads.

Embodiments are conceivable where fewer guiding means are employed. The guiding means may be realized in many different ways, as long as at least one of the lowermost arms of the scissor assembly is horizontally guided. The same is the case for the uppermost arms. At least one of the uppermost arms is to be horizontally guided. It is, however, a disadvantage of the embodiments with fewer guiding means, that this leads to a disturbance of the symmetry of the overall assembly.

The guiding means at the lower end of the scissor assembly may be designed with a main focus on the aspect of horizontal guidance. In this case, most of weight of the elevator car, the load and the weight of the scissor assembly—herein referred to as total weight—is to be carried by the central drive. The shaft and/or the screw and/or the nut of the screw drive have to be designed accordingly. In another embodiment, the guiding means may be designed with a focus on the aspect of horizontal guiding and the mounting of the scissor assembly plus elevator car. In this case, the central drive would have to carry a smaller part of the total weight.

An elevator according to the present invention may comprise a gear box or the like for drivingly connecting the electric motor to the screw shaft or nut. In FIG. 2, the enlarged portion of the drive 26, at the tops of the electric motor 22 and the housing 25, can enclose a gear box and an electric brake of conventional construction.

Due to the fact that the central drive provides for a vertical guidance of the cross element or the scissor assembly, and due to the fact that at least one cross element is used to connect the two scissor columns, a very stable and rigid elevator is obtained. The elevator, according to the present invention does not require any guiding elements—such as guiding rails—for controlling movements of the elevator car in a hoistway in the vertical direction. It is even possible to install the inventive elevator without any hoistway.

Symmetry is a crucial issue. In particular when being operated, it is important to ensure that the two scissor columns move concurrently. According to the present invention this is achieved by employing a central drive that applies forces to the scissor assembly only at a central portion in order to ensure that the whole system is balanced.

Due to this it is ensured that the elevator car is kept generally always horizontal. The elevator according to the present invention is in itself stable.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A scissor assembly for carrying an elevator car, comprising:
a pair of generally vertically extending scissor columns each having a lower end adapted to engage a support surface and an upper end adapted to be attached underneath the elevator car, each of said scissor columns including at least one pair of arms which are pivotally movable relative to one another between a folded position and an unfolded position;
at least one cross element coupling said scissor columns together for cooperative vertical movement; and
a drive mechanism mechanically coupled with both said scissor columns for applying a force in an upward vertical direction for unfolding the scissor assembly from the folded position to the unfolded position.

2. The scissor assembly according to claim 1 wherein said arms of each of said pairs of arms cross at an intersection and are rotatably connected at the intersection.

3. The scissor assembly according to claim 2 wherein said at least one cross element is connected between the intersections.

4. The scissor assembly according to claim 1 wherein said drive mechanism is connected to said at least one cross element.

5. The scissor assembly according to claim 4 wherein said drive mechanism is connected at a middle section of said at least one cross element.

6. The scissor assembly according to claim 1 wherein said drive mechanism is an electromechanical drive.

7. The scissor assembly according to claim 6 wherein said electromechanical drive is a screw drive.

8. The scissor assembly according to claim 6 wherein said electromechanical drive is one of an ACME screw drive with a high strength screw shaft and a nut made of bronze or a synthetic material, a ball screw drive with an externally threaded ballscrew shaft and an internally threaded nut, a caged ball screw drive, and a planetary roller screw drive.

9. The scissor assembly according to claim 1 further comprising a brake for performing at least one of holding the scissor assembly on a given level, compensating for, at least partially, forces pointing downwards, and damping downward movements.

10. The scissor assembly according to claim 1 further comprising a mounting platform adapted to be situated on a ground surface, said mounting platform carrying at least one of said drive and said scissor columns.

11. The scissor assembly according to claim 10 wherein said mounting platform includes terminal buffers for damping a downward movement of the scissor assembly.

12. The scissor assembly according to claim 10 wherein said mounting platform includes guiding means for engaging and horizontally guiding said lower ends of said scissor columns.

13. The scissor assembly according to claim 12 including springs acting on said arms to oppose folding of the scissor assembly.

14. The scissor assembly according to claim 1 wherein each of said scissor columns comprises a plurality of pairs of said arms.

15. An elevator comprising:
an elevator car;
a scissor assembly supporting said elevator car and extending between underneath said elevator car and a support surface, said scissor assembly having a pair of scissor columns being vertically arranged, each of said scissor columns having at least one pair of arms which are pivotally movable relative to one another between a folded position and an unfolded position;
a drive mechanism connected to said scissor assembly; and
at least one cross element connecting said scissor columns, said drive mechanism being adapted to mechanically interact with said scissor columns for applying a force in a vertical direction for unfolding said scissor assembly and thus lifting said elevator car.

16. The elevator according to claim 15 wherein said arms of said at least one pair of arms are rotatably connected at an intersection of said arms.

17. The elevator according to claim 16 wherein said at least one cross element is connected between said intersections of said pairs of arms.

18. The elevator according to claim 15 wherein said drive mechanism is connected with said at least one cross element.

19. The elevator according to claim 15 including a mounting platform adapted to engage the support surface, said mounting platform supporting said scissor assembly and said drive mechanism.

20. The elevator according to claim 15 wherein said elevator car, said scissor assembly and said drive mechanism are adapted to be arranged in a hoistway.
